(19) United States
(12) Patent Application Publication
(10) Pub. No.: US 2011/0137779 A1
(43) Pub. Date: Jun. 9, 2011

(54) SHINGLES CUTTING APPARATUS AND METHOD THEREOF

(76) Inventor: Stéphane Gendron, Sorel-Tracy (CA)

(21) Appl. No.: 12/959,312

(22) Filed: Dec. 2, 2010

Related U.S. Application Data
(60) Provisional application No. 61/267,168, filed on Dec. 7, 2009.

(51) Int. Cl. B23D 45/14; B23D 45/04; B26D 3/24; G06Q 30/00

(52) U.S. Cl. 705/34; 83/472; 83/473; 83/13

(57) ABSTRACT

Is hereby provided an apparatus for batch cutting shingles, the apparatus comprising a table including a carriage module for receiving a plurality of shingle sheets thereon; and a power pack module supported by the table and operatively connected to a cutting module including at least two cutting blades mounted on a support arm, the two cutting blades being disposed at an angle thereof and adapted to simultaneously cut the plurality of shingle sheets to produce a plurality of shingle caps. A method of billing shingles cuttings with an apparatus for batch cutting shingle sheets and a method of cutting bundles of sheaves is also provided.

### CROSS-REFERENCE

The present United States patent application relates to and claims priority from U.S. provisional patent application No. 61/267,168, filed Dec. 7, 2009, entitled CAP'S CUTTER, which is incorporated herein by reference.

### TECHNICAL FIELD

The technical field relates to shingles cutting apparatuses. More precisely, the present technical field relates to a shingle caps cutter apparatus.

### BACKGROUND

Asphalt shingles are commonly installed on roofs to prevent water infiltration in buildings. They also have an aesthetic purpose if only for their color. New constructions nowadays tend to have a plurality of gable and attic windows. Every ridge requires to be capped with shingle caps to prevent water infiltration thereof and to improve the uniformity of the roof finishing.

A significant number of shingle caps can be required on a single roof. It is not rare to find 5, 10 and even more complete bundles of asphalt shingles cut to cap all the roof ridges. This makes a lot of shingle caps obtained with a lot of work in addition to the risks of getting injured in the process of cutting each shingle in caps.

Therefore, a need has been felt for a shingle cutting apparatus that can cut sheaves in caps. It is also desirable to provide a shingle cutting apparatus that can batch process the cutting of shingles and a method of monitoring cuttings thereof. Another need, inter alia, has been felt over the existing art for computerized shingle cutting apparatus adapted to monitor and calculate the number of cuts made with the apparatus.

### SUMMARY

It is one aspect of the present invention to alleviate one or more of the drawbacks of the background art by addressing one or more of the existing needs in the art.

At least one embodiment of the present invention provides an apparatus for batch cutting asphalt shingles to convert each shingle in a plurality of asphalt shingle caps; the apparatus being adapted to simultaneously make a plurality of cuts and provided with a sliding table to effortlessly move a bundle of shingles at the time in a desired cutting position; a plurality of diamond coated circular blade are arranged in a layout configured to adequately cut one or more shingle caps at the same time; one or more motors are operatively connected to the blades and adapted to be powered at the request of a user; spring loaded arms are effortlessly moved by the user to locate and move the blades as desired by the user; the circular blades are adapted to move deep in the plurality of asphalt shingles so that a tangential portion of the blade is reaching the complete depth of each cut.

At least one embodiment of the present invention provides an apparatus for batch cutting asphalt shingles.

At least one embodiment of the present invention provides an apparatus for batch cutting asphalt shingles into an asphalt shingles caps.

At least one embodiment of the present invention provides an apparatus for batch cutting asphalt shingles including a plurality of blades or cutting members to simultaneously perform a plurality of cuts.

At least one embodiment of the present invention provides an apparatus for batch cutting asphalt shingles including a plurality of spring-loaded blade-supporting arms.

At least one embodiment of the present invention provides an apparatus for batch cutting asphalt shingles including a plurality of angularly adjustable spring-loaded blade-supporting arms.

At least one embodiment of the present invention provides an apparatus for batch cutting asphalt shingles including pre-set cutting positions.

At least one embodiment of the present invention provides an apparatus for batch cutting asphalt shingles including at least one blade-supporting arm provided with pivotal and translation motion capability.

At least one embodiment of the present invention provides an apparatus for batch cutting asphalt shingles accompanied with a mechanism capable of 1) sensing when a user is next to the apparatus; 2) sensing the activation of the motor; 3) sensing the angular movement of the blade-supporting arm; 4) sensing the translational movements of the blade-supporting arm; and 5) calculating the amount of time the apparatus is used.

At least one embodiment of the present invention provides an apparatus for batch cutting asphalt shingles that is connectable to a network for transmitting data from the apparatus to a computer.

At least one embodiment of the present invention provides an apparatus for batch cutting asphalt shingles equipped with a camera for recording the use of the apparatus.

At least one embodiment of the present invention provides a network-ready apparatus for batch cutting asphalt shingles.

At least one embodiment of the present invention provides a method of billing for the use of an apparatus for batch cutting asphalt shingles considering, inter alia, the number of cuts made with the apparatus.

At least one embodiment of the present invention provides an apparatus for batch cutting shingles, the apparatus comprising a table including a carriage module for receiving a plurality of shingle sheets thereon; and a power pack module supported by the table and operatively connected to a cutting module including at least two cutting blades mounted on a support arm, the two cutting blades being disposed at an angle thereof and adapted to simultaneously cut the plurality of shingle sheets to produce a plurality of shingle caps.

At least one embodiment of the present invention provides a method of billing shingles cuttings with an apparatus for batch cutting shingle sheets, the method comprising sensing a cut of shingle sheets with blades of the apparatus for batch cutting shingle sheets and sending a signal thereof; and providing a price based, at least in part, on the number of sensed cut performed with the shingle cutting apparatus.

At least one embodiment of the present invention provides a method of cutting bundles of sheaves comprising providing a bundle of shingles; placing the bundle of shingles on a carriage; rotating a plurality of circular blades disposed at an angle thereof; and cutting the bundle of shingles with the plurality of circular blades to make a pile of shingles caps.

Other objects, aspects and further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Additional and/or alternative advantages and salient features of the invention will become apparent from the following detailed description, which, taken in conjunction with the annexed drawings, disclose preferred embodiments of the invention.

### BRIEF DESCRIPTION OF THE FIGURES

FIG. 1 shows an isometric illustration of a shingles cutting apparatus in accordance with an embodiment of the present invention;

FIG. 2 shows a top plan view of a shingles cutting apparatus in accordance with an embodiment of the present invention;

FIG. 3 shows an isometric illustration of a portion of the shingles cutting apparatus in accordance with an embodiment of the present invention;

FIG. 4 shows an exploded isometric illustration of a portion of the shingles cutting apparatus in accordance with an embodiment of the present invention;

FIG. 5 shows an exploded isometric illustration of a portion of the shingles cutting apparatus in accordance with an embodiment of the present invention;

FIG. 6 depicts an isometric illustration of the shingles cutting apparatus in a specific cutting position in accordance with an embodiment of the present invention;

FIG. 7 depicts an isometric illustration of the shingles cutting apparatus in a specific cutting position in accordance with an embodiment of the present invention;

FIG. 8 depicts an isometric illustration of the shingles cutting apparatus in a specific cutting position in accordance with an embodiment of the present invention;

FIG. 9 depicts an isometric illustration of the shingles cutting apparatus in a specific cutting position in accordance with an embodiment of the present invention.

FIG. 10 depicts an isometric illustration of the shingles cutting apparatus in a specific cutting position in accordance with an embodiment of the present invention.

FIG. 11 depicts an isometric illustration of the shingles cutting apparatus in a specific cutting position in accordance with an embodiment of the present invention.

FIG. 12 depicts an isometric illustration of the shingles cutting apparatus in a specific cutting position in accordance with an embodiment of the present invention.

FIG. 13 depicts an isometric illustration of the shingles cutting apparatus in a specific cutting position in accordance with an embodiment of the present invention.

FIG. 14 depicts an isometric illustration of the shingles cutting apparatus in a specific cutting position in accordance with an embodiment of the present invention.

FIG. 15 depicts an isometric illustration of the shingles cutting apparatus in a specific cutting position in accordance with an embodiment of the present invention.

FIG. 16 depicts a top plan view of a sheet of shingle in accordance with an embodiment of the present invention.

FIG. 17 depicts a top plan view of three caps cut from a sheet of shingle in accordance with an embodiment of the present invention.

FIG. 18 is a right side elevational view of the shingles cutting apparatus in accordance with an embodiment of the present invention.

FIG. 19 is a magnified view of a portion of the shingles cutting apparatus of FIG. 18.

FIG. 20 is a magnified view of a portion of the shingles cutting apparatus of FIG. 18;

FIG. 21 is an isometric view of the shingles cutting apparatus in accordance with an embodiment of the present invention.

FIG. 22 is a magnified view of a portion of the shingles cutting apparatus of FIG. 21.

FIG. 23 is a block diagram of a communication system associated with the FIG. 18 is a right side elevational view of the depicts a top plan view of the shingles cutting apparatus in accordance with an embodiment of the present invention.

FIG. 24 is an illustration of a network connecting a plurality of shingles cutting apparatuses in accordance with an embodiment of the present invention; and

FIG. 25 is an illustrative flow chart of a method of billing the use of shingles cutting apparatuses in accordance with an embodiment of the present invention.

### DETAILED DESCRIPTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

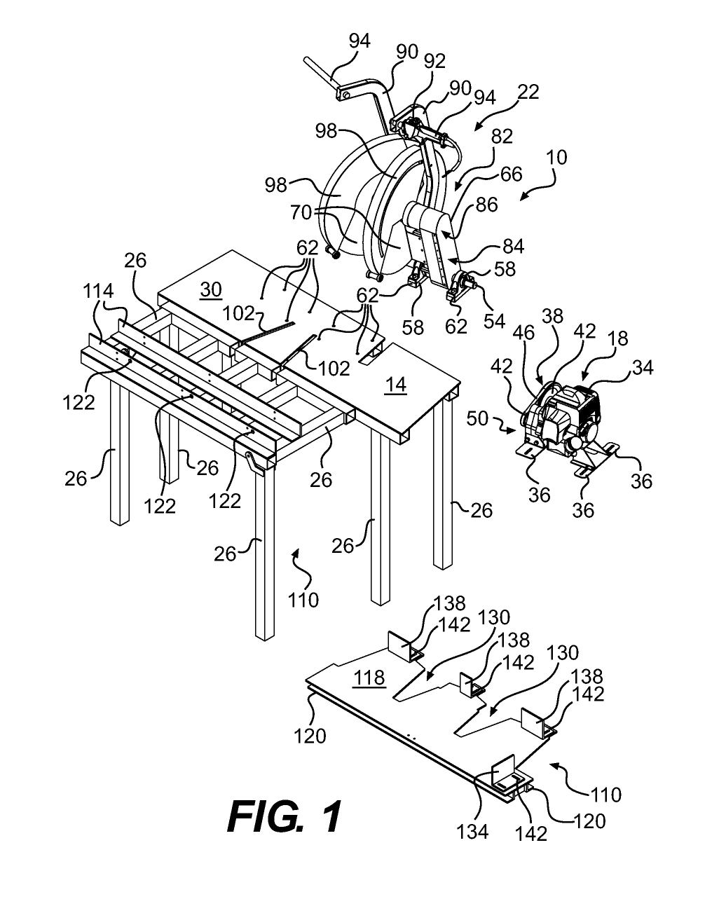

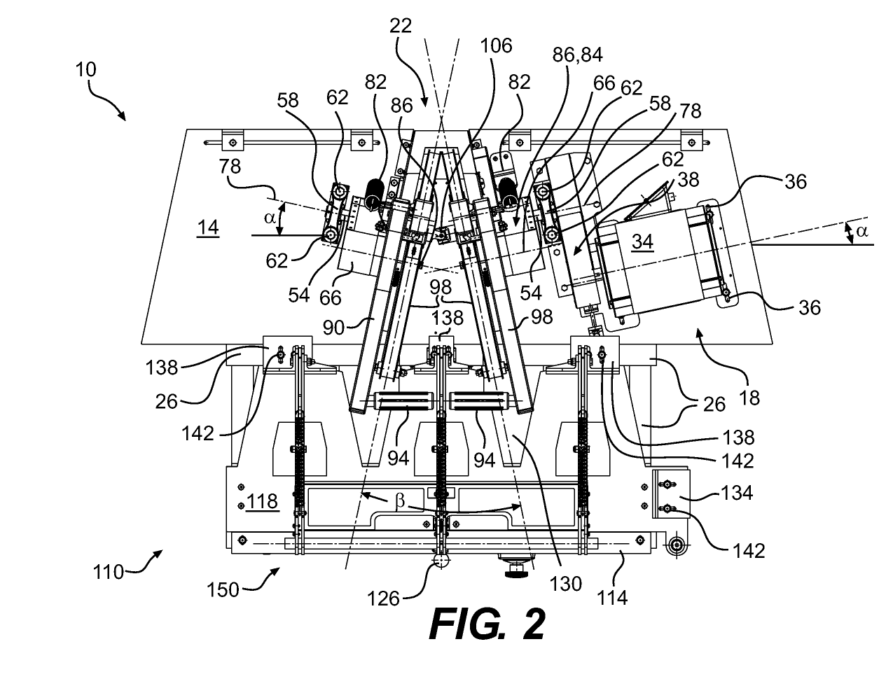

In respect with an embodiment of the invention, FIG. 1 and FIG. 2 illustrate a shingles cutting apparatus 10. The shingles cutting apparatus 10 includes a table 14 adapted to support a power pack module 18 and a cutting module 22. The table 14 can be made of welded metallic members 26 and sheet metal 30 as shown in FIG. 1. The table could also be made of formed sheet metal (not shown), casted parts (not shown), injected and fiber charged plastic (not shown) or from any suitable material suitable for this type of shingles cutting apparatus 10.

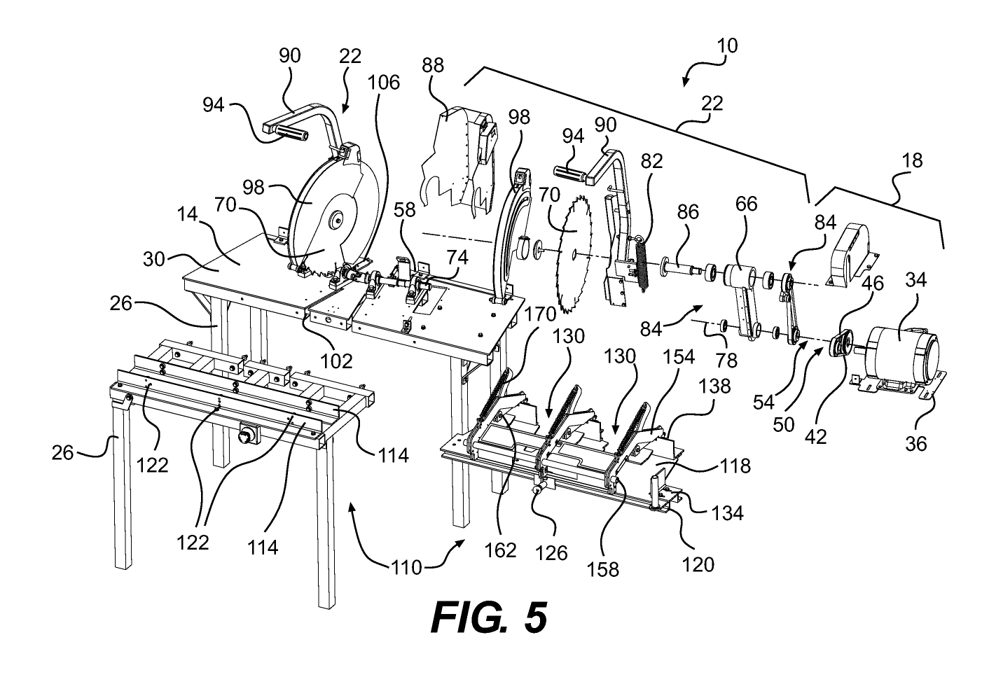

The power pack module 18 illustrated in FIG. 1 and FIGS. 6-13 is an internal combustion engine 34 similar to utility four-stroke engines sold by companies like Honda®. The power pack module 18 is removably and adjustably secured to the table 14 with a series of slots 36 and fasteners (not shown). An electric motor, shown in FIG. 2 and FIG. 5, or a pneumatic motor (not shown) could alternatively be used and remains within the scope of the present application. The power pack module 18 can be directly operatively connected to the cutting module 22 and have a 1:1 transmission ratio. The internal combustion engine 34 of the present embodiment is associated with a secondary transmission 38 adapted to change the transmission ratio thereof. In the present situation the secondary transmission 38 includes two pulleys 42 used in conjunction with an interconnecting endless belt 46. A power pack drive 50 is provided and adapted to operatively connect with a counterpart cutting module drive 54. A vibration damper (not shown) and/or a quick drive connection (not shown) could alternatively be used to operatively connect the power pack module 18 with the cutting module 22.

A motor 34 is used in the present embodiment to rotate the cutting module drive 54. In an alternate embodiment, a plurality of motors (not shown) could be used on the shingles cutting apparatus 10. The plurality of motors 34 could be operatively connected in series to power the cutting module 22. In contrast, each motor of the plurality of motors 34 can be operatively connected to its respective cutting blade 70.

The cutting module 22 of the present embodiment includes a plurality of diamond coated circular blades 70 adapted for cutting shingles. The cutting module 22 is secured to the table 14 via a plurality of bearing units 58 provided with slots and holes 62 sized and designed to receive fasteners (not shown) therein to fasten the cutting module 22 to the table 14. The presently embodied cutting module 22 includes two circular blades 70. Two bearing units 58 are used to pivotally secure an arm 66 to which is operatively secured a circular blade 70. The arm 66 pivots about an axle 74 defining an arm pivot axis 78 and is spring-loaded with spring 82 (not visible on FIG. 1) and biased in the upper position. The arm 66 mechanically supports the circular blade 70 and includes a drive mechanism 84 therein transmitting the power from the cutting module drive 54 to the circular blade axle 86. The arm 66 is also accompanied with a safety guard 88 protecting a user against the moving transmission parts thereunder. The drive mechanism 84 contained in the arm 66 might be composed of two pulleys and an interconnecting endless belt as it can be seen in FIG. 5. A series of interconnected gears or a drive shaft with relevant associated sets of gears (not shown) could alternatively be used.

The arm 66 is provided with an elongated handlebar 90 secured thereto on a first end and to which is connected a handle 94 on a second end. The handlebar 90 is a lever multiplying the strength of a user pushing down the circular blade 70 toward the shingle material to cut. The spring-loaded arm 66 raises back the handlebar 90 in its upper position when the user reduces the down force applied thereon. A switch 92 is located on, or about, to the handle 94 to selectively power the cutting module 22. A safety guard 98 covers the circular blade 70 to prevent direct accidental contact of a user with the circular blade 70. The safety guard 98 does not cover a lower portion of the circular blade 70 to allow contact of the circular blade 70 with the material to cut. The table 14 is also provided with slots 102 therein to allow the circular blade 70 to get sufficiently low to perform the entire cut.

As best seen in FIG. 2, the second circular blade 70 (illustrated on the left side of FIG. 2) is supported with a similar arrangement of parts: a second handlebar 90, handle 94 and safety guard 98 are provided therewith. It can be appreciated that the two circular blades 70 are disposed at an angle α thereof. The angle α is representative of the desired shape of a side cut of shingle caps, as it will be discussed below with more details. The angle between both circular blades 70 is adjustable to allow cutting caps with different side angles. Preferably, both sides of the caps are symmetrically cut. Slots and pivots could be provided in the table 14 to provide some adjustments (not illustrated in the Figures). A single motor 34 is used in the present embodiment and the power is drawn between the two circular blades 70 with a universal joint 106 installed therebetween.

The table 14 is further provided with a carriage module 110. The carriage module 110 is adapted to receive thereon one or a plurality of asphalt shingles and move laterally in respect with the cutting module 22. The carriage module 110 can be built in the table 14 of the shingles cutting apparatus 10. Conversely, as it is depicted in the present embodiment, the lower portion of the carriage module 110 is fastened to the table 14 and can be removed to ease transport. Rails 114 are installed on the table 14 to receive thereon the carriage 118 equipped with cooperating rails 120 provided underneath. One rail 114 of the carriage module 110 includes a plurality of locating holes 122 used to locate the transversal position of the carriage 118. A spring-loaded plunger 126, visible in FIG. 2, is used to laterally secure the carriage 118 to the table 14 thus preventing undesirable movements therebetween. Three distinct carriage positions are provided to locate the carriage at the positions required to cut three sets of shingle caps from one shingle sheet, as it will be discussed in further details below.

The carriage 118 includes a plurality of “V” shaped indentations 130 allowing the circular blades 70 to be lowered without cutting the carriage 118. The shape of the indentations 130 could change depending on the positions of the circular blades 70 without departing from the scope of the present invention. Carriages 118 having different indentation shapes 130 can also be provided in a kit of parts or as a separate addition to an existing shingles cutting apparatus 10.

Moreover, the carriage 118 is provided with a lateral stopper 134 and a plurality of rear stoppers 138 to properly locate the sheet of shingles to be cut with the shingles cutting apparatus 10. All the stoppers 134, 138 are adjustably secured to the carriage 118 with slots 142 and fasteners.

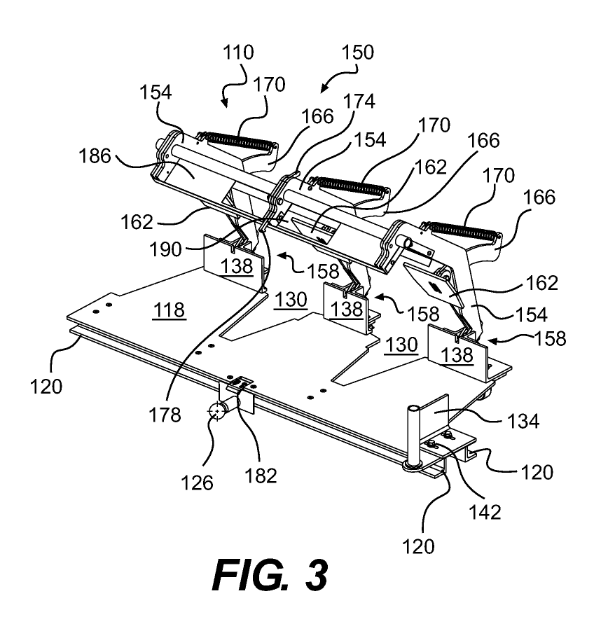

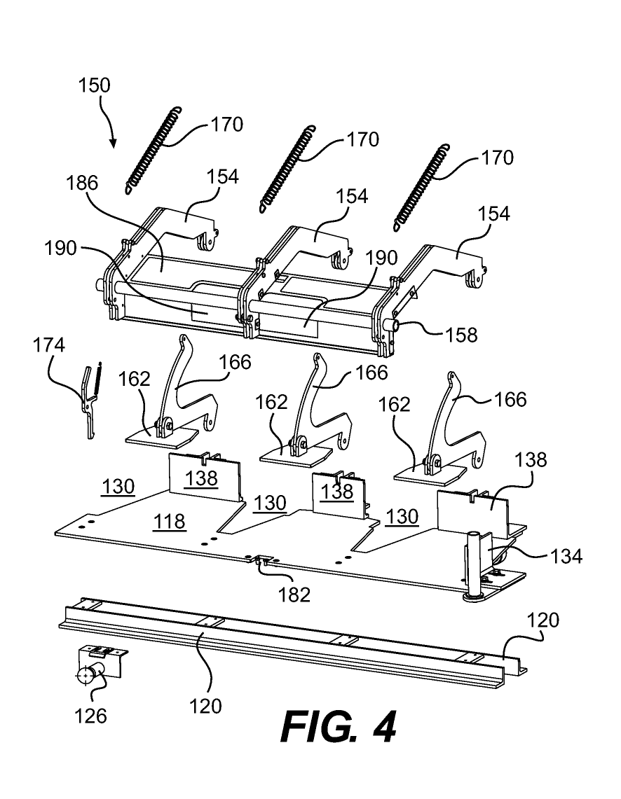

As best seen in FIG. 2, FIG. 3 and FIG. 4, the carriage module 110 is further equipped with a clamping mechanism 150 for securing the shingles to the carriage 118. The clamping mechanism 150 is provided with a plurality of connector members 154 pivotally affixed to the rear stoppers 138 with pivots 158 defined thereof. Each connector member 154 is associated with a spring loaded pressure plate 162 secured to linkage members 166. The pressure plates 162 are adapted to contact the shingles disposed on the carriage 118 and use the strength of the springs 170 to apply pressure thereon. The force generated by the springs 170 helps lock the locking mechanism 174 when the hook 178 engages the hook-receiving portion 182. The clamping mechanism 150 further includes a front stopper 186 adapted to further secure the shingles on the carriage 118 and defines some openings 190 therein to see the side and the thickness of shingles secured on the carriage 118. An exploded view of the shingles cutting apparatus 10 is illustrated in FIG. 5 for a better overview of the structure.

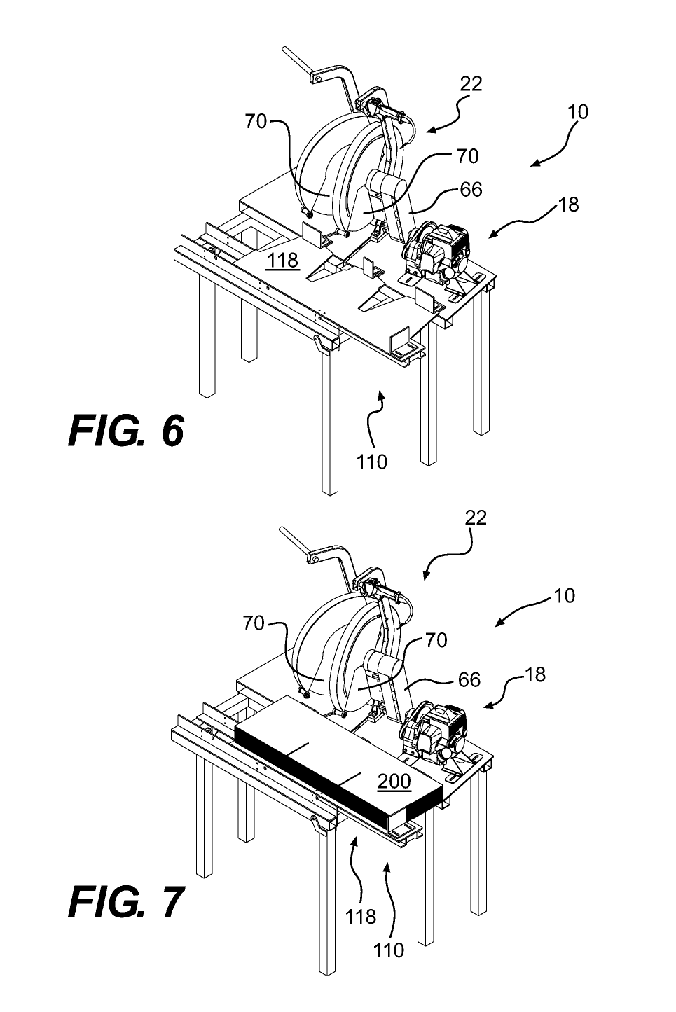

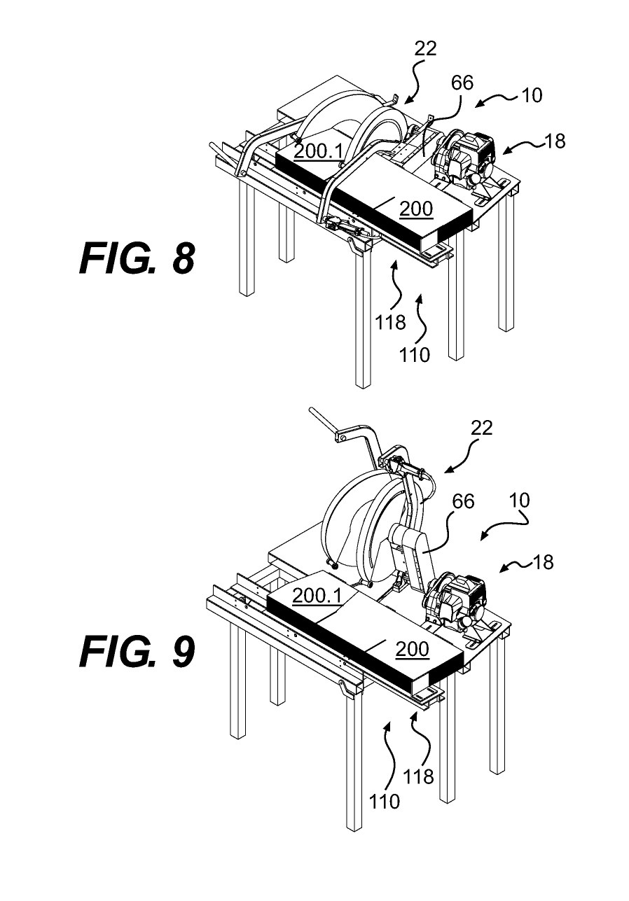

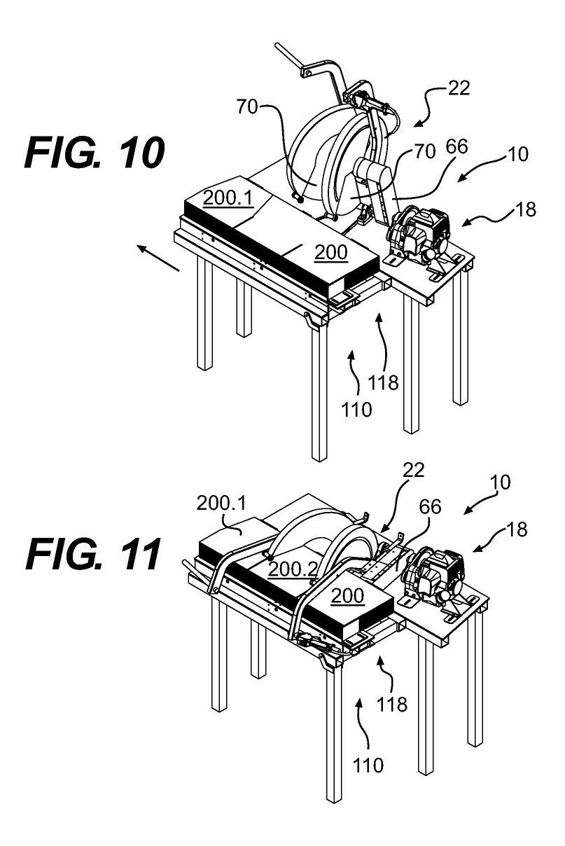

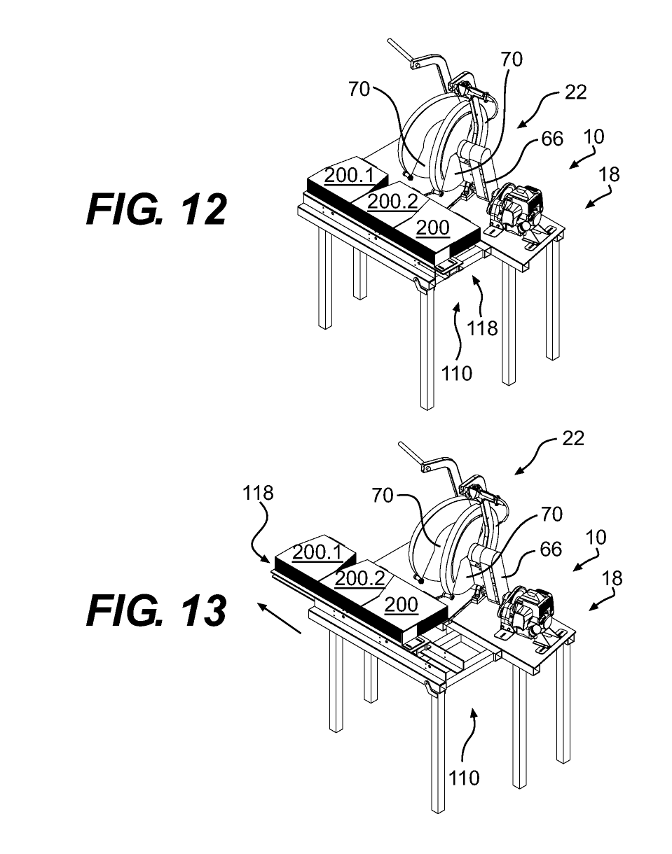

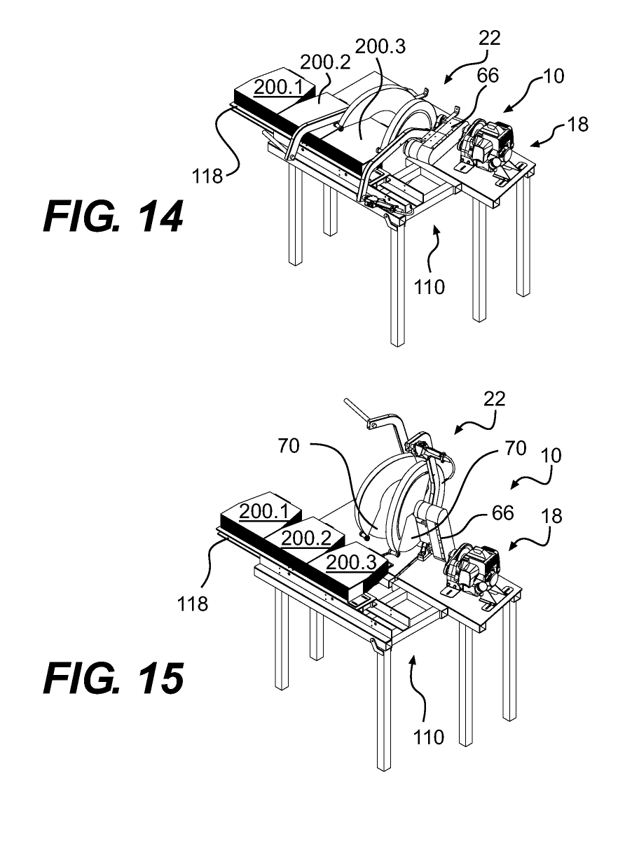

Turning now to the series of FIG. 6 through FIG. 15 illustrating various operating positions of the carriage 118 in respect with the pair of circular blades 70. FIG. 6 illustrates the carriage 118 in its rightmost position without any sheets of shingles 200 thereon whereas FIG. 7 depicts the same carriage 118 position as FIG. 6 with a plurality of sheets of shingles 200 thereon. FIG. 8 shows a cut of the shingles 200 to produce a first pile of caps 200.1. FIG. 9 illustrates when the arms 66 are raised back in their upper position. The carriage 118 is pushed one position left in FIG. 10. The circular blades 70 are cutting the shingles in FIG. 11 to produce a second pile of caps 200.2. FIG. 12 illustrates when the arms 66 are raised back in their upper position. The carriage 118 is pushed one position left in FIG. 13. The circular blades 70 are cutting the shingles in FIG. 14 to produce a third pile of caps 200.3. FIG. 15 depicts the arms 66 in their upper position.

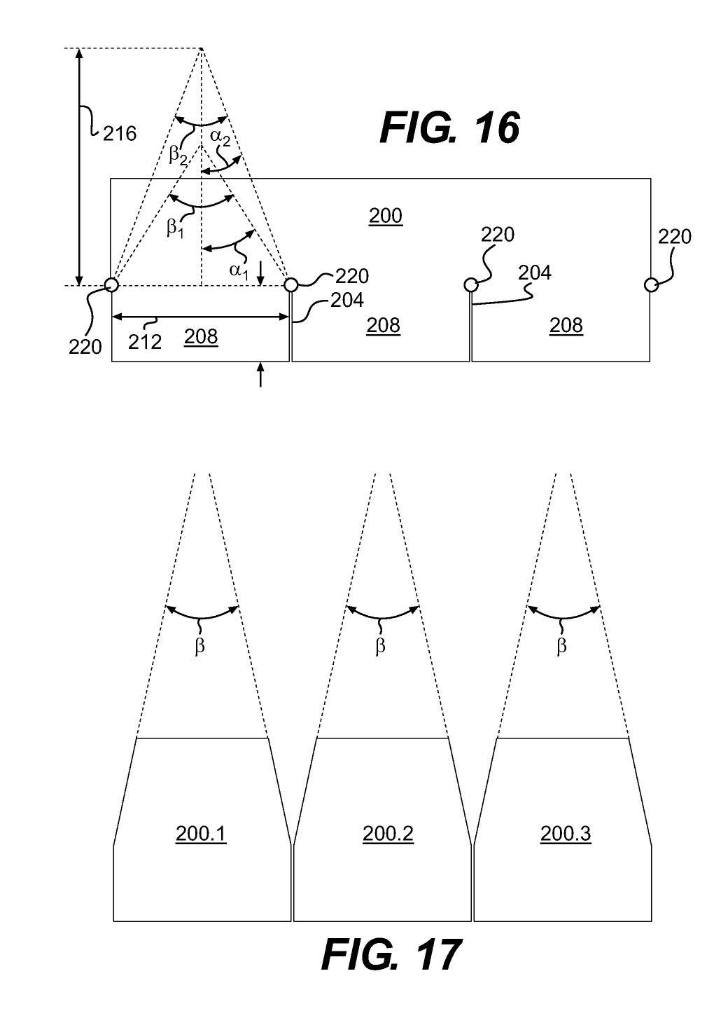

A typical sheet of shingle 200 is illustrated in FIG. 16. The sheet of shingle 200 of the present embodiment includes three separations 204 that half separate the sheet of shingle 200 into three substantially identical shingle portions 208 having a substantially identical width 212. Each shingle portion 208 is going to be transformed into a cap 200.1, 200.2 and 200.3 as it can be appreciated from FIG. 17. The angle β (that is in fact two times the angle α between the circular blades 70 and the distance 216 should be adjusted such that the circular blades 70 are reaching the proximal end 220 of two juxtaposed separations 204 in a sheet of shingle 200 to maximize the surface of the sheet of shingle 200. The distance 216 indicating the position where the planes of the circular blades 70 intersect. The distance 216 would be equal to:

$$( distance 216 ) = \frac{( distance 212 / 2 )}{Tan α} \qquad Equation 1$$

FIG. 17 illustrates three caps 200.1, 200.2 and 200.3 cut from a sheet of shingle 200 in accordance with an embodiment of the present invention.

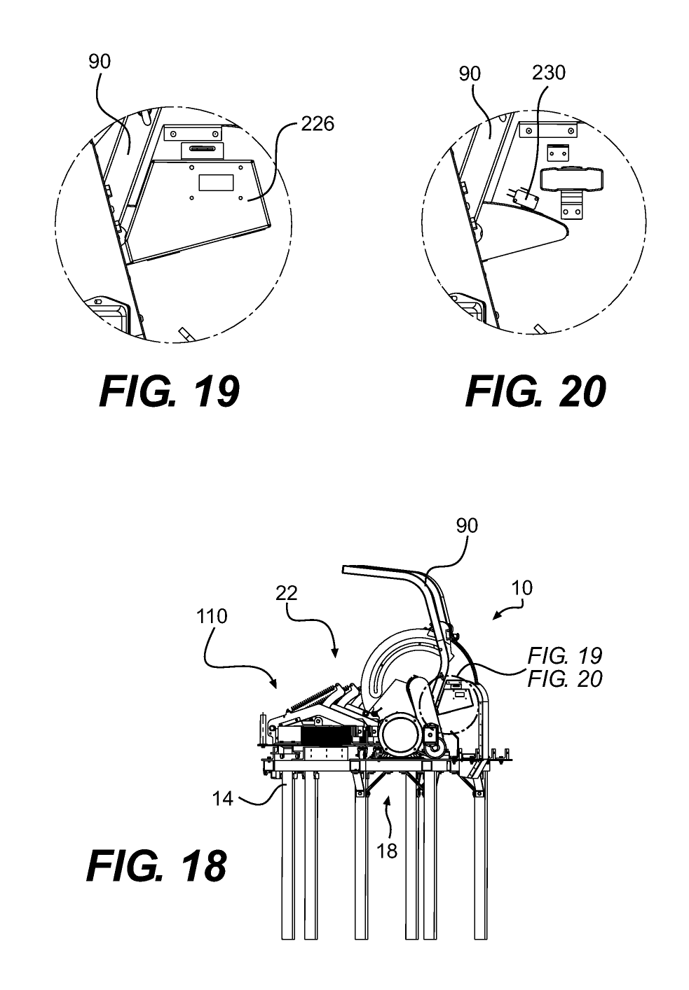

Referring now to FIG. 18 illustrating a shingles cutting apparatus 10 with a sensor 230 protected by a cover 226 as seen in FIG. 19 and FIG. 20. The sensor 230 is used to send a signal when the arm 90 is in its upper position or not. The signal from sensor 230 is primarily used to increase a counter indicating the number of times the arm 90 has been moved from its upper position. The movement of the arm 90 is one possible way to calculate the number of cut made by the shingles cutting apparatus 10.

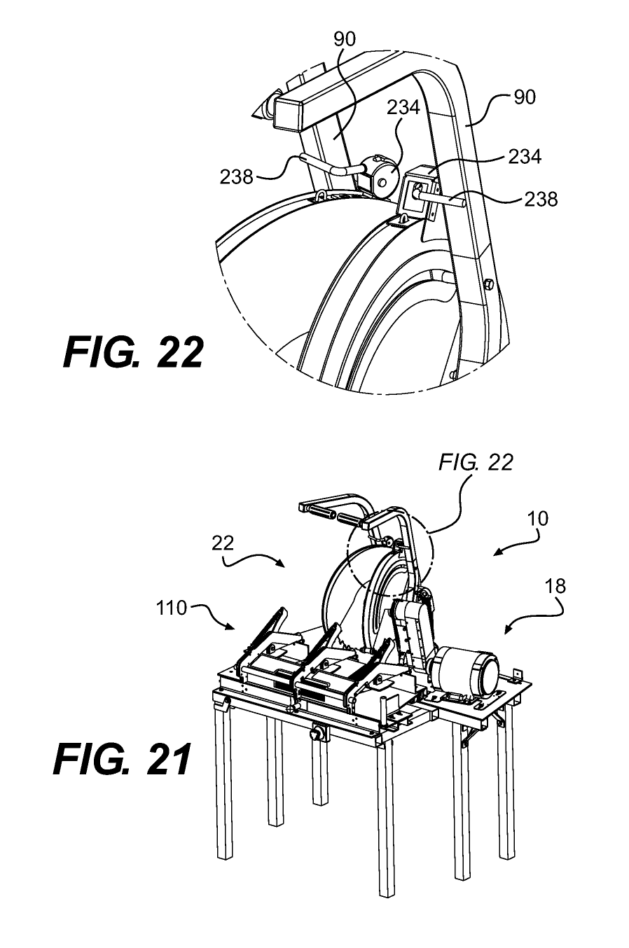

An alternate embodiment is illustrated in FIG. 21 and FIG. 22. A mechanical counting device 234 is actuated, via actuating member 238, each time the arm 90 is moved. The number of cut made with the shingles cutting apparatus 10 can be inferred from the number of time the arm 90 has been moved.

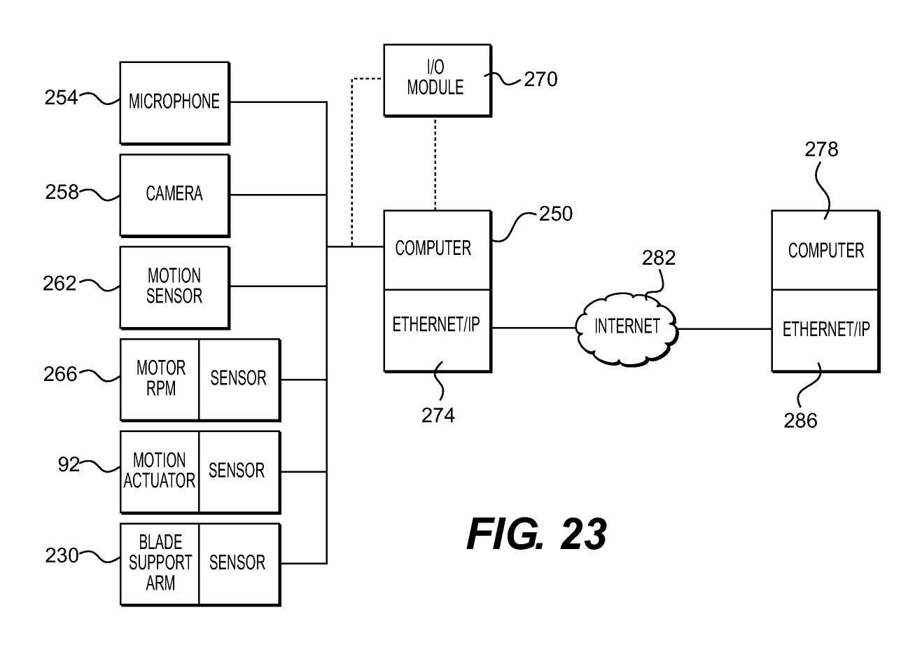

Turning now to FIG. 23 illustrating a schematic system connecting the shingles cutting apparatus 10 with a network-ready computer system 250 to monitor the use of the shingles cutting apparatus 10. Firstly there are some possible sensors that can be collectively of individually used in cooperation with the computer system 250. A microphone 254, a camera 258, a motion sensor 262, a motor RPM sensor 266, a motor actuation sensor 92 and/or an arm position sensor 230 are operatively connected to a computer system 250 via (or directly) an I/O module 270. An Ethernet or IP communication interface 274 is connected to the computer system 250 to send data to a counterpart computer system 278 via Internet 282, or another type of network, and a counterpart I/O module 286.

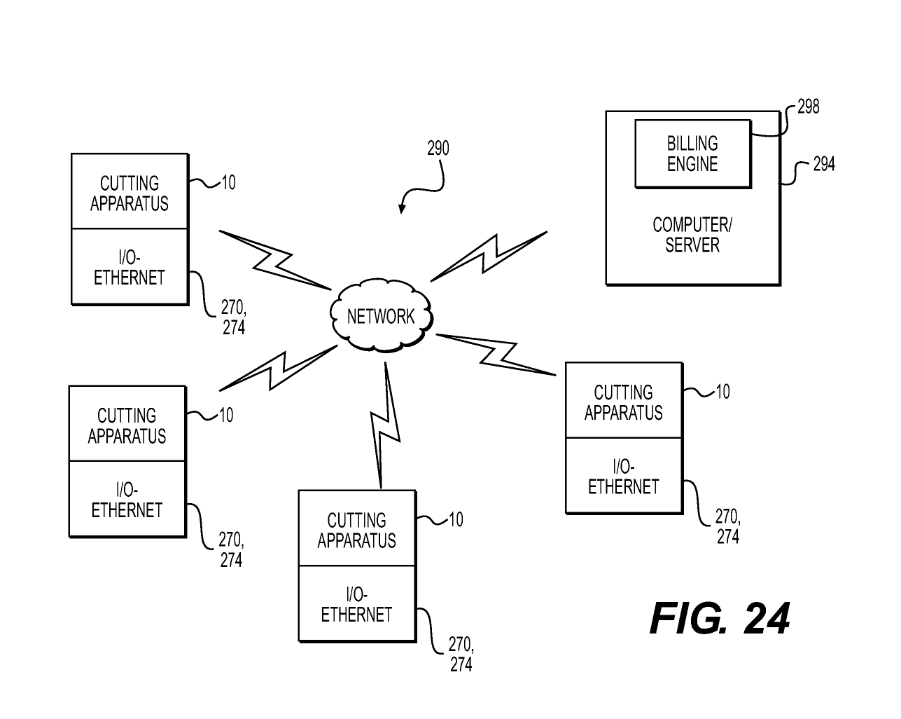

The electronic signal communication provided by the system illustrated in FIG. 23 is adapted to create a network 290 of interconnected shingles cutting apparatus 10 with optionally appended I/O modules 270, 274 as it can be appreciated in FIG. 24. The network of shingles cutting apparatuses 10 are also networked with a counterpart computer/server 294 adapted to make cost of use analysis with a billing engine 298 associated therewith. The cost of use analysis is based, at least in part, on the data collected from the various sensors identified in FIG. 23.

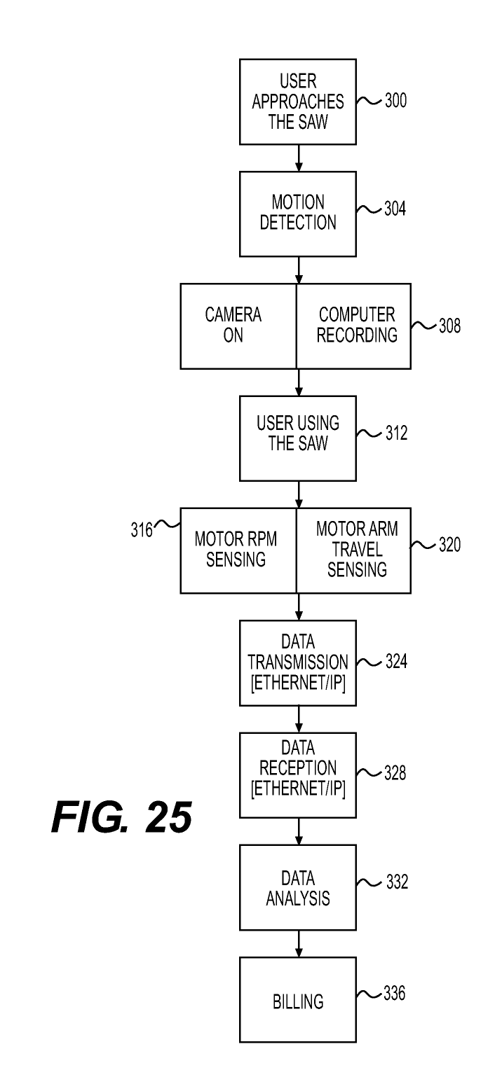

A method of billing the use of the shingles cutting apparatus 10 is illustrated in the block diagram of FIG. 25. The camera 258 or another motion detection 304 sensor 262 is used to wake up the system 250 that a user is nearby 300 the shingles cutting apparatus 10. The camera 258 is used to collect images and the microphone is used to collect sound of the use of the shingles cutting apparatus 10. The computer 250 starts recording 308 while the user uses the saw 312. The motor RPM 316 and the position 320 of the arm 90 is sensed and the data thereof is sent 324 through the network 290 and received 328 by a counterpart computer 294. The data is analyzed 332 by the counterpart computer 294 and a billing engine 298 to define a cost associated with the use of the shingles cutting apparatus 10 and provides billing/invoicing 336 thereof.

The description and the drawings that are presented above are meant to be illustrative of the present invention. They are not meant to be limiting of the scope of the present invention. Modifications to the embodiments described may be made without departing from the present invention, the scope of which is defined by the following claims:

What is claimed is:

1. An apparatus for batch cutting shingles, the apparatus comprising:
a table including a carriage module for receiving a plurality of shingle sheets thereon; and
a power pack module supported by the table and operatively connected to
a cutting module including at least two cutting blades mounted on a support arm, the two cutting blades being disposed at an angle thereof and adapted to simultaneously cut the plurality of shingle sheets to produce a plurality of shingle caps.

2. The apparatus of claim 1, further comprising a support arm for each cutting blade.

3. The apparatus of claim 1, wherein the cutting blades are not coaxial and are operatively interconnected with an angular drive member.

4. The apparatus of claim 1, wherein the carriage is moveable to locate the plurality of shingle sheets in a position to simultaneously cut the plurality of shingle sheets with the two cutting blades to produce a second plurality of shingle caps.

5. The apparatus of claim 1, wherein the carriage module is removably secured to the table whereby the carriage module and the table be disconnected to ease transportation thereof.

6. The apparatus of claim 1, wherein an individual motor powers each cutting blade.

7. The apparatus of claim 1, wherein the cutting blades are angularly adjustable thereof.

8. The apparatus of claim 1, wherein the carriage module further comprises a shingle sheets holding mechanism for securing the sheets of shingle to the table.

9. The apparatus of claim 1, wherein the apparatus for batch cutting shingles is adapted to cut a complete unpacked package asphalt shingle sheets.

10. The apparatus of claim 1, further comprising a data collection system adapted to sense a number of cuts performed with the apparatus for batch cutting shingles and adapted to send data about the number of cuts through a network.

11. A method of billing shingles cuttings with an apparatus for batch cutting shingle sheets, the method comprising:
sensing a cut of shingle sheets with blades of the apparatus for batch cutting shingle sheets and sending a signal thereof; and
providing a price based, at least in part, on the number of sensed cut performed with the shingle cutting apparatus.

12. The method of claim 11, further comprising sending the signal representative of the actuation from an apparatus for batch cutting shingles through a network.

13. The method of claim 12, further comprising sensing movement next to the apparatus for batch cutting shingle sheets with a motion sensor prior to sensing the cut of shingle sheets.

14. The method of claim 12, wherein the cut of shingle sheets is sensed with a support arm sensor.

15. The method of claim 12, wherein the cut of shingle sheets is sensed with a cutting blade actuation sensor.

16. The method of claim 12, further comprising recording images and sound of the use of the apparatus for batch cutting shingle sheets.

17. A method of cutting bundles of sheaves comprising:
providing a bundle of shingles;
placing the bundle of shingles on a carriage;
rotating a plurality of circular blades disposed at an angle thereof; and
cutting the bundle of shingles with the plurality of circular blades to make a pile of shingles caps.

18. The method of claim 17, comprising:
securing the bundle of shingles to the carriage;
translating the carriage;
securing the carriage to avoid further translation thereof; and
cutting the bundle of shingles with the plurality of circular blades to make a second pile of shingles caps.

19. The method of claim 18, comprising:
unsecuring the carriage to allow translation thereof;
translating the carriage;
securing the carriage to avoid further translation thereof;
cutting the bundle of shingles with the plurality of circular blades to make a third pile of shingles caps; and
unsecuring the three piles of shingles.
